(19) United States
(12) Patent Application Publication
(10) Pub. No.: US 2026/0085017 A1
(43) Pub. Date: Mar. 26, 2026

(54) STRUCTURAL MEMBER

(71) Applicant: TOTO LTD., Fukuoka (JP)

(72) Inventors: Atsushi KINJO, Fukuoka (JP); Tatsuya KOGA, Fukuoka (JP)

(73) Assignee: TOTO LTD., Fukuoka (JP)

(21) Appl. No.: 19/314,701

(22) Filed: Aug. 29, 2025

(30) Foreign Application Priority Data
Sep. 26, 2024 (JP) 2024-167513
Jan. 29, 2025 (JP) 2025-013267

(51) Int. Cl. C04B 41/50; C04B 35/10; C04B 41/00; C04B 41/45; C04B 41/87; C04B 41/91

(52) U.S. Cl. CPC C04B 41/5055; C04B 35/10; C04B 41/009; C04B 41/4529; C04B 41/87; C04B 41/91; C04B 2235/3217; C04B 2235/445

(57) ABSTRACT

Provided is a structural member with sufficient durability against plasma while having a protective film that can be easily removed from the base material. The structural member 10 includes a base material 100 which is a ceramic sintered body, and a protective film 200 covering the surface 110 of the base material 100. The protective film 200 includes, as a main component, any one selected from the group consisting of an alkaline earth metal oxide, an alkaline earth metal fluoride, and an alkaline earth metal acid fluoride, and has an indentation hardness of 8 GPa or less.

### CROSS-REFERENCE TO RELATED APPLICATION

This application is based upon and claims the benefit of priority from Japanese Patent Application No. 2024-167513 filed on Sep. 26, 2024, and Japanese Patent Application No. 2025-013267 filed on Jan. 29, 2025, the entire contents of which are incorporated herein by reference.

### Field

The present invention relates to a structural member.

### BACKGROUND

Structural members having a protective film on the surface of a base material are used in various fields such as a semiconductor manufacturing apparatus. For example, as disclosed in Japanese Translation of PCT International Application Publication No. 2016-528380, a protective film for protecting a base material from plasma is formed on the surface of the base material forming chamber inner walls of a semiconductor manufacturing apparatus. A ceramic sintered body such as alumina is used as the base material. A rare earth oxide such as yttria (Y₂O₃), a rare earth fluoride such as yttrium fluoride (YF₃), and a rare earth oxyfluoride such as yttrium oxyfluoride (YOF) are often used for the protective film.

When processes such as etching are repeated in a semiconductor manufacturing apparatus, the protective film degrades gradually. Therefore, the structural member including the deteriorated protective film must be replaced with a new structural member at regular intervals. The structural member removed from the semiconductor manufacturing apparatus is reused after the old, deteriorated protective film is removed from the base material and a new protective film is formed on the surface of the base material.

### SUMMARY

The deteriorated protective film is removed from the surface of the base material, for example, by applying physical force such as grinding and polishing. In this case, the greater the hardness of the protective film, the greater the force required to remove it, resulting in increased damage to the surface of the base material. If the surface properties of the base material, such as roughness, change significantly upon removal of the protective film, a process to restore the surface properties of the base material is required before forming a new protective film. One approach is to reduce the physical force applied to the protective film to a level that avoids changes in the surface properties of the base material; however, this significantly increases the time required for removing the protective film.

Furthermore, a protective film comprising a rare earth oxide as a main component is considered to have greater durability against plasma as its hardness increases. Patent Literature 1 discloses the use of a high-hardness material for the protective film to resist wear during plasma processing. In recent years, higher durability against plasma has been required for protective films, and materials with higher hardness tend to be used for protective films. Thus, removing protective films while substantially retaining the surface properties of the base material is considered to become increasingly difficult henceforth.

The present invention has been made in view of such problems, and an object of the present invention is to provide a structural member with sufficient durability against plasma while having a protective film that can be easily removed from the base material.

To solve the above problem, the structural member of the present invention comprises a base material which is a ceramic sintered body, and a protective film covering the surface of the base material. The protective film comprises, as a main component, any one selected from the group consisting of an alkaline earth metal oxide, an alkaline earth metal fluoride, and an alkaline earth metal acid fluoride, and has an indentation hardness of 8 GPa or less.

When a rare earth oxide is used as the material for the protective film as in the prior art, it is considered necessary to increase the hardness of the protective film to about 10 GPa, and the protective film has been formed under conditions to achieve such hardness.

On the other hand, the present inventors have found through experiments that using any one selected from the group consisting of an alkaline earth metal oxide, an alkaline earth metal fluoride, and an alkaline earth metal acid fluoride as a material for the protective film enables the protective film to exhibit durability against plasma comparable to that in the prior art without increasing its hardness.

Thus, in the structural member configured as described above, an alkaline earth metal oxide or the like is used as the material for the protective film, while its indentation hardness is maintained at 8 GPa or less. This protective film has durability against plasma comparable to that of conventional protective films and can be easily removed while substantially retaining the surface properties of the base material as described above.

According to the present invention, a structural member with sufficient durability against plasma while having a protective film that can be easily removed from the base material can be provided.

### BRIEF DESCRIPTION OF THE DRAWINGS

FIG. 1 schematically illustrates a cross-section of the structural member according to the present embodiment;

FIGS. 2A and 2B illustrate changes in surface properties of the base material; and

FIG. 3 is a table listing experimental results for surface properties of the base material after removing the protective film.

### DETAILED DESCRIPTION

Hereinafter the present embodiment will be described with reference to attached drawings. For clarity of description, identical reference numerals are used to denote the same elements in all figures, and redundant descriptions are omitted.

The structural member 10 of the present embodiment is a member used for the inner wall of a process chamber of a semiconductor manufacturing apparatus, such as plasma etching apparatus (not shown). The use of the structural member 10 in the present embodiment is merely an example, and not limited to the use in semiconductor manufacturing apparatuses.

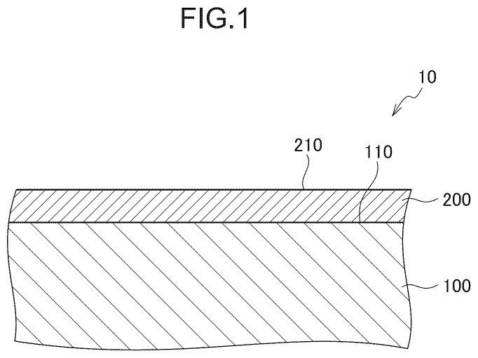

As shown in FIG. 1, the structural member 10 includes a base material 100 and a protective film 200.

In a plasma etching apparatus or the like, the surface 210 of the protective film 200 is exposed to the interior of the process chamber. The protective film 200 is formed to protect the surface 110 of the base material 100 from plasma.

The base material 100 is a member forming the primary portion of the structural member 10. In the present embodiment, the base material 100 is a sintered ceramic body including high-purity aluminum oxide (Al₂O₃) as a main component, but may be a different type of ceramic sintered body. The surface 110 of the base material 100 is flat in the present embodiment, but may be curved. A portion of the surface 110 may be inclined.

The protective film 200 is formed to protect the base material 100 from plasma as described above. The protective film 200 is formed to cover the entire surface 110 of the base material 100. A material comprising, as a main component, any one selected from the group consisting of an alkaline earth metal oxide, an alkaline earth metal fluoride, and an alkaline earth metal acid fluoride is used as the material for the protective film 200. The thickness of the protective film 200 is appropriately adjusted depending on the duration for which durability is required to be maintained and other factors. In the present embodiment, the protective film 200 has a thickness of about 10 μm or less.

In the present description, the “main component” refers to a compound present in the protective film 200 in a greater amount than other compounds, as determined by quantitative or semi-quantitative X-ray diffraction (XRD) analysis of the protective film 200. For example, the main component is the compound present in the protective film in the greatest amount, and the proportion of the main component in the protective film exceeds 50% by volume or mass. The proportion of the main component is more preferably more than 70%, and further preferably more than 90%. The proportion of the main component may be 100%.

Examples of alkaline earth metal oxides described above include magnesium oxide. Examples of alkaline earth metal fluoride include calcium fluoride (CaF₂) and magnesium fluoride (MgF₂). Examples of alkaline earth metal acid fluoride include magnesium acid fluoride and calcium acid fluoride.

The film forming method and film forming conditions may be configured such that the protective film 200, formed using any one of the above materials, has an indentation hardness of 8 GPa or less. The reason is as follows.

When processes such as etching are repeated in a semiconductor manufacturing apparatus, the protective film 200 degrades gradually. Therefore, the structural member 10 including the deteriorated protective film 200 must be replaced with a new structural member 10 at regular intervals. The structural member 10 removed from the semiconductor manufacturing apparatus is reused after the old, deteriorated protective film 200 is removed from the base material 100 and a new protective film 200 is formed on the surface 110 of the base material 100.

The deteriorated protective film 200 is removed from the surface 110 of the base material 100, for example, by applying physical force such as grinding and polishing.

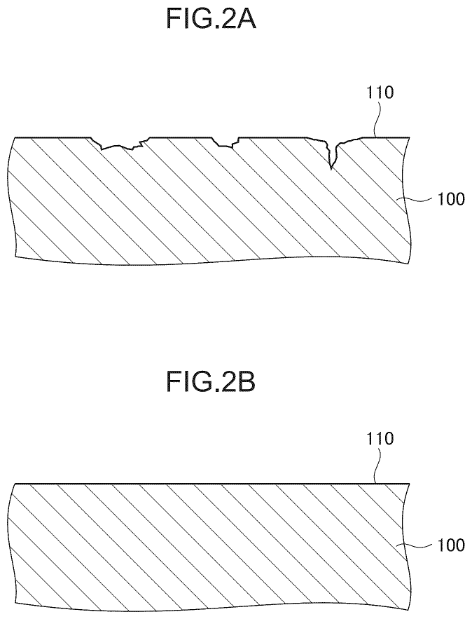

In this case, the greater the hardness of the protective film 200, the greater the force required to remove it, resulting in increased damage to the surface 110 of the base material 100. For example, the mechanical force may cause phenomena such as the detachment of some crystallites from the surface 110, and as a result the surface 110 may become rough, as shown in the example of FIG. 2A.

If the properties of the surface 110, such as roughness, change significantly upon removal of the protective film 200, a process to restore the properties of the surface 110 is required before forming a new protective film 200. One approach is to reduce the physical force applied to the protective film 200 to a level that avoids changes in the properties of the surface 110; however, this significantly increases the time required for removing the protective film 200.

Thus, in the present embodiment, the indentation hardness of the protective film 200 is maintained at 8 GPa or less as described above. By maintaining the hardness of the protective film 200 to this degree, damage to the surface 110 of the base material 100 can be sufficiently suppressed during removal of the protective film 200 by applying mechanical force. For example, as shown in FIG. 2B, the protective film 200 can be easily removed from the surface 110 with minimal change in the properties of the surface 110. Subsequently, when reforming the protective film 200 on the surface 110, the process for restoring the properties of the surface 110 can be simplified compared to the prior art or eliminated.

A material comprising a rare earth oxide such as yttria as a main component has been conventionally used as a material for the protective film. It has been understood that a protective film with greater hardness exhibits higher durability against plasma. In recent years, higher durability against plasma has been required for protective films, and materials with higher hardness tend to be used for protective films. Thus, removing protective films while substantially retaining the surface properties of the base material is considered to become increasingly difficult henceforth.

Under such circumstances, the present inventors have considered the use of a material comprising an alkaline earth metal, not rare earth elements, as the material for the protective film. As a result, the present inventors have found that using any one selected from the group consisting of an alkaline earth metal oxide, an alkaline earth metal fluoride, and an alkaline earth metal acid fluoride as a material for the protective film enables the protective film to exhibit durability against plasma comparable to that in the prior art without increasing its hardness.

Based on the above findings, the present inventors have arrived at the idea that while using an alkaline earth metal oxide or the like as the material for the protective film 200 as in the present embodiment, the indentation hardness of the protective film 200 is maintained at 8 GPa or less. This configuration enables the provision of a protective film 200 that maintains durability against plasma comparable to that of conventional protective films and can be easily removed while substantially retaining the surface properties of the base material 100.

Given recent international circumstances, there is concern that materials such as rare earth oxides, previously used for the protective film, may face challenges in securing a stable and continuous supply in the future. Using an alkaline earth metal oxide as an alternative material for the protective film 200, as in the present embodiment, is preferable from the viewpoint of supply stability.

The present inventors prepared numerous samples of the structural member 10, each varying in the material of the protective film 200, and evaluated surface properties of the base material 100 after removal of the protective film 200 and other characteristics through experiments.

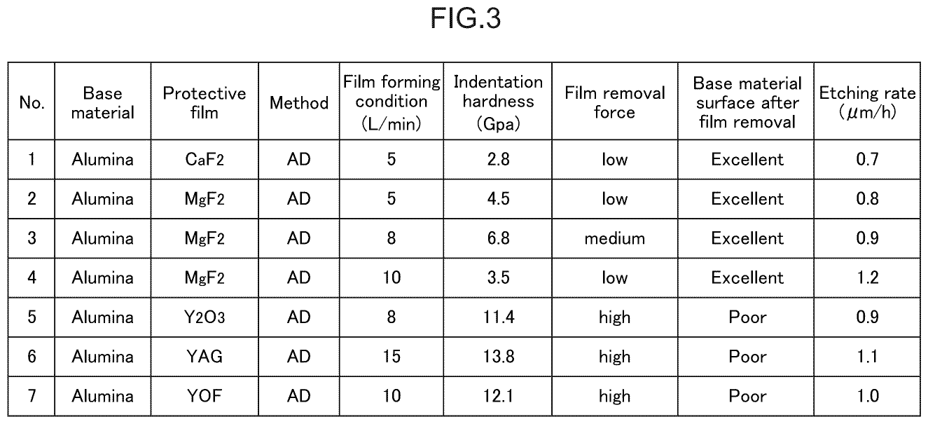

FIG. 3 lists part of the experimental results. Of Samples Nos. 1 to 7 whose results are shown in FIG. 3, Nos. 1 to 4 are samples of the structural member 10 of the present embodiment. Nos. 5 to 7 are samples of the structural member 10 of Comparative Examples.

The “Base material” column in the table of FIG. 3 indicates the main component contained in the base material 100 of each sample. In the examples of FIG. 3, the base material 100 of all samples includes alumina as the main component.

The “Protective film” column in the table of FIG. 3 indicates the main component contained in the protective film 200 of each sample. The protective film 200 No. 1 includes calcium fluoride (CaF₂) as the main component. The protective films 200 Nos. 2, 3, and 4 include magnesium fluoride (MgF₂) as the main component. The protective film 200 No. 5 includes yttria (Y₂O₃) as the main component. The protective film 200 No. 6 includes yttrium aluminum garnet (YAG) as the main component. The protective film 200 No. 7 includes yttrium oxyfluoride (YOF) as the main component. For each sample, the protective film 200 was formed with a uniform thickness.

The “Method” column in the table of FIG. 3 indicates the film forming method used for forming the protective film 200 of each sample. In the examples of FIG. 3, the protective film 200 of all samples is formed by the aerosol deposition (AD) method. Various methods other than the aerosol deposition method may be used as the method for forming the protective film 200. For example, a physical vapor deposition (PVD) method or a chemical vapor deposition (CVD) method may be used to form the protective film 200.

As is well known, in the aerosol deposition method, fine particles, the material of the protective film 200, are dispersed in gas to form aerosol, which is then sprayed to the surface 110 of the base material 100 from a nozzle to cause collision. On the surface 110, the fine particles are deformed or fragmented due to the impact of collisions, bonding to each other and gradually depositing as the protective film 200.

The “Film forming condition” column in the table of FIG. 3 indicates the flow rate of helium gas sprayed from the nozzle per unit time in L/minute. The flow rate for forming the protective films 200 Nos. 1 and 2 was 5 L/minute; the flow rate for forming the protective films 200 No. 3 was 8 L/minute; the flow rate for forming the protective films 200 No. 4 was 10 L/minute; the flow rate for forming the protective films 200 No. 5 was 8 L/minute; the flow rate for forming the protective film 200 No. 6 was 15 L/minute; and the flow rate for forming the protective film 200 No. 7 was 10 L/minute.

The “Indentation hardness” column in the table of FIG. 3 indicates the measured value of the indentation hardness of the protective film 200 of each sample in GPa. The indentation hardness of the protective film 200 No. 1 was 2.8 GPa; the indentation hardness of the protective film 200 No. 2 was 4.5 GPa; the indentation hardness of the protective film 200 No. 3 was 6.8 GPa; the indentation hardness of the protective film 200 No. 4 was 3.5 GPa; the indentation hardness of the protective film 200 No. 5 was 11.4 GPa; the indentation hardness of the protective film 200 No. 6 was 13.8 GPa; and the indentation hardness of the protective film 200 No. 7 was 12.1 GPa.

The indentation hardness of each protective film 200 was measured by performing a nanoindentation test for the surface 210. The indentation hardness (H_{IT}) was measured using a Berkovich indenter with an indentation depth fixed at 200 nm. The measurement sites of H_{IT} on the surface 210 were portions of the surface free of scratches or pits. The measurement may be conducted after polishing the surface 210 to form a flat surface. The number of measurement sites was at least 25. The average of the measured H_{IT} values of the at least 25 sites was determined as the indentation hardness of each sample. Other specific measurement conditions were based on ISO 14577, and their explanation is omitted here.

The “Film removal force” column in the table of FIG. 3 indicates the magnitude of force required to physically remove the protective film 200 from the base material 100, expressed on a three-level scale of “high,” “medium,” and “low.” The force applied to each sample was individually adjusted so that the time required for the thickness of the protective film 200 to reach zero was the same for each sample.

The film removal force for the samples in which the protective film 200 included a conventional rare earth material as a main component, i.e., Samples Nos. 5, 6, and 7, was “High”, the film removal force for Sample No. 3 was “Medium”, and the film removal force for Samples Nos. 1, 2, and 4 was “Low.” As described above, in Samples Nos. 1, 2, and 4 of the present embodiment, the protective film 200 was found to be easily removable with less force than that required in conventional methods.

The “Base material surface after film removal” column in the table of FIG. 3 presents the results of observing the properties of surface 110 exposed after removing the protective film 200 of each sample. When the exposed surface 110 substantially retained its original properties before forming the protective film 200, it was rated as “Excellent”. When the original properties of the surface 110 significantly changed, it was rated as “Poor”. The results of the evaluation of the surface 110 for Samples Nos. 1 to 4 were all “Excellent”, and the results of the evaluation of the surface 110 for Samples Nos. 5 to 7 were all “Poor”. As described above, in all of Samples Nos. 1 to 4 of the present embodiment, the original properties of the surface 110 before forming the protective film 200 was found to be substantially retained immediately after the removal of the protective film 200. That is, it has been found that a new protective film 200 can be formed directly on the surface 110 after removal of the protective film 200, without performing an additional process to restore its properties.

The present inventors evaluated the durability against plasma for Samples Nos. 1 to 7. For the evaluation, the protective film 200 of each sample was exposed to a plasma atmosphere using an inductively coupled plasma reactive ion etching (ICP-RIE) apparatus. The chamber pressure was 0.5 Pa, and the time of exposure to plasma was 1 hour. The power output was set such that the coil power for ICP was 1500 W, and the bias power was 750 W. Sulfur hexafluoride (SF₆) was used as process gas, and it was supplied into the chamber at a flow rate of 100 sccm. After exposure to plasma was completed, the reduction in thickness per unit time, i.e., the etching rate, of the protective film 200 of each sample was measured. In the column “Etching rate” of the table shown in FIG. 3, the depth etched per unit time for the protective film 200 of each sample exposed to plasma under the above conditions is shown in units of “μm/h.”

As a result, FIG. 3 indicates that the etching rates of all Samples Nos. 1 to 7 were found to be substantially equivalent. In other words, the protective films 200 of Samples Nos. 1 to 4 of the present embodiment were found to exhibit durability against plasma comparable to that of Samples Nos. 5 to 7 of Comparative Examples.

As described above, when the protective film 200 comprises any one selected from the group consisting of an alkaline earth metal oxide, an alkaline earth metal fluoride, and an alkaline earth metal acid fluoride as a main component, and has an indentation hardness of 8 GPa or less, the protective film 200 was found to exhibit sufficient durability against plasma. It has also been found that the protective film 200 can be easily removed from the base material 100 with minimal change in the properties of the surface 110.

The protective film 200 may bave a thickness of 1 μm or more and 15 μm or less. By setting the thickness of the protective film 200 within this range, both the durability of the protective film 200 against plasma and the ease of removing it from the base material 100 can be achieved.

The crystal forming the protective film 200 may have an average crystallite size of 50 nm or less. By reducing the average crystallite size to this extent, the diameter of particles generated when the protective film 200 is exposed to plasma and degrades can be sufficiently reduced.

The “average crystallite size” mentioned above refers to the average diameter of crystallites observed in a cross-section of the protective film 200 when it is sectioned. The average crystallite size is calculated, for example, as the average diameter of 15 crystallites, determined by circular approximation from an image obtained using a transmission electron microscope (TEM) at a magnification of 400,000× or higher. By reducing the sample thickness to approximately 30 nm during focused ion beam (FIB) processing, crystallites can be more clearly identified. The magnification may be appropriately selected in the range of 400,000× or higher.

The present embodiment has been described with reference to examples. However, the present disclosure is not limited to these examples. Modifications made to the foregoing examples by those skilled in the art fall within the scope of the present disclosure, provided that they retain the characteristics of the present disclosure. The elements of the foregoing examples, including their configurations, conditions, shapes, and the like, are not limited to those illustrated and can be modified as appropriate. The elements of the foregoing examples can be variously combined, provided that no technical contradiction arises.

What is claimed is:

1. A structural member comprising:
a base material which is a ceramic sintered body, and
a protective film covering a surface of the base material,
wherein the protective film comprises, as a main component, any one selected from the group consisting of an alkaline earth metal oxide, an alkaline earth metal fluoride, and an alkaline earth metal acid fluoride, and
the protective film has an indentation hardness of 8 GPa or less.

2. The structural member according to claim 1, wherein the base material comprises alumina as a main component.

3. The structural member according to claim 1, wherein the protective film comprises, as a main component, any one selected from the group consisting of magnesium fluoride and calcium fluoride.

4. The structural member according to claim 1, wherein the protective film has a thickness of 1 μm or more and 15 μm or less.

5. The structural member according to claim 1, wherein crystal forming the protective film has an average crystallite size of 50 nm or less.
